(19) United States
(12) Patent Application Publication
(10) Pub. No.: US 2026/0243915 A1
(43) Pub. Date: Aug. 20, 2026

(54) NON-ROTATIONAL AZIMUTHAL RESISTIVITY TOOL

(71) Applicant: Halliburton Energy Services, Inc., Houston, TX (US)

(72) Inventors: Michael Bittar, Houston, TX (US); Hsu Hsiang Wu, Houston, TX (US); Yijing Fan, Singapore (CN)

(73) Assignee: Halliburton Energy Services, Inc., Houston, TX (US)

(21) Appl. No.: 19/056,445

(22) Filed: Feb. 18, 2025

(51) Int. Cl. G01V 3/30; E21B 7/00; E21B 49/00

(52) U.S. Cl. CPC G01V 3/30; E21B 7/00; E21B 49/00

(57) ABSTRACT

A method and system for identifying one or more properties in a formation. The method may include disposing a logging sub into a wellbore, wherein the logging sub comprises a plurality of multi-physical electromagnetic antennas and performing a slide drilling operation to extend the wellbore into a formation. The method may further include taking one or more measurements with the logging sub and identifying one or more properties of the formation from the one or more measurements.

### BACKGROUND

Modern petroleum drilling and production operations may demand a great quantity of information relating to the parameters and conditions downhole. Such information typically includes the location and orientation of the borehole and drilling assembly, earth formation properties, and parameters of the downhole drilling environment. The collection of information relating to formation properties and downhole conditions is commonly referred to as “logging” and may be performed during the drilling process itself (hence the term “logging while drilling” or “LWD,” frequently used interchangeably with the term “measurement while drilling” or “MWD”).

Various measurement tools exist for use in LWD. One such tool is the resistivity tool, which includes one or more antennas for transmitting an electromagnetic signal into the formation and one or more antennas for receiving a formation response. Physical phenomena that determine how the measurement is made may vary with frequency, for example. In some examples, the amplitude and/or the phase of the receive signals are compared to the amplitude and/or phase of the transmit signals to measure the formation resistivity. In other cases, the amplitude and/or phase of multiple receive signals are compared to each other to measure the formation resistivity.

When plotted as a function of depth or tool position in the borehole, the logging tool measurements are termed “logs.” Resistivity logging may be used in well logging to determine geological correlation of formation strata and detect and quantify potentially productive formation zones. Such logs may provide indications of hydrocarbon concentrations and other information useful to drillers and completion engineers. In particular, azimuthally-sensitive logs may provide information useful for steering the drilling assembly because they may inform the driller when a target formation bed has been entered or exited, thereby enabling modifications to the drilling program that will provide much more value and higher success than would be the case using only seismic data.

Generally, resistivity inversion algorithms make logging-while-drilling (LWD) resistivity tools leverage a tilted antenna design to achieve azimuthal sensitivity to surrounding formations. The tilted antenna design is utilized as LWD operations generally rotate the drilling string and logging subs. However, certain downhole applications, such as coiled tubing interventions, do not allow the tool to rotate while in motion. This may be referred to as a slide drilling operation, where the bottom hole assembly (BHA) remains stationary while drilling into the formation, allowing for static measurements to be taken at a specific depth along the wellbore. As a result, conventional azimuthal resistivity tools are unable to provide directional measurements in these scenarios.

### BRIEF DESCRIPTION OF THE DRAWINGS

These drawings illustrate certain aspects of some examples of the present disclosure and should not be used to limit or define the disclosure.

FIG. 1 illustrates an example of a coiled tubing string;

FIG. 2 illustrates an example of a logging sub that may be disposed on the coiled tubing string;

FIG. 3 is a schematic of an information handling system;

FIG. 4 is a schematic of a chipset that may be utilized by the information handling system;

FIG. 5 is a schematic of an arrangement of resources on a computer network;

FIG. 6 illustrates the rotation of a logging sub in a conventional logging-while-drilling (LWD) operation;

FIG. 7 illustrates a triaxial antenna configuration in a logging sub utilized during wireline operations;

FIGS. 8-12 illustrate different embodiments of the logging sub with different configurations of receivers and transmitters;

FIG. 13 illustrates the detailed workflow of the logging sub operations that mimics azimuthal measurements without requiring rotation of the logging sub;

FIG. 14 is a graph illustrating assigned bins disposed around the logging sub in which measurements may be taken;

FIG. 15 illustrates a two-layered, one-dimensional (1D) formation model to evaluate the azimuthal measurements of a conventional LWD logging sub disposed on a BHA that rotates when taking azimuthal measurements and the logging sub disposed on the BHA that is non-rotational when taking azimuthal measurements;

FIGS. 16A-16C are graphs that display the synthetic azimuthal measurements obtained from measurements taken by the BHA in FIG. 15 for attenuation resistivity;

FIGS. 17A-17C are graphs that display the synthetic azimuthal measurements obtained from measurements taken by the BHA in FIG. 15 for phase resistivity;

FIG. 18 illustrates evaluation of the logging sub's high side directions at varying angles relative to the normal direction of the formation boundary (relative bed azimuth);

FIGS. 19A-19C are graphs that illustrate synthetic modeling responses for both tools in the formation model in FIG. 17 for attenuation resistivity;

FIGS. 20A-20C graphs that illustrate synthetic modeling responses for both tools in the formation model in FIG. 17 for phase resistivity;

FIG. 21 illustrates a proposed using a symmetrical antenna structure;

FIGS. 22A-22C are graphs that compare the azimuthal measurements obtained using BHA's featuring the symmetrical antenna structure described in FIG. 19 for attenuation resistivity;

FIGS. 23A-23C are graphs that compare the azimuthal measurements obtained using BHA's featuring the symmetrical antenna structure described in FIG. 19 for phase resistivity;

FIG. 24 illustrates logging sub 116 which may comprise four physical receivers for measuring signals from transmitter to create pseudo antenna measurements; and

FIGS. 25A & 25B illustrate measurement superposition of multi-antenna configurations of the logging sub to form pseudo antenna configurations.

### DETAILED DESCRIPTION

This disclosure may generally relate to systems and methods for multi-component tools designed to calculate azimuthal responses by capturing specific components essential for directional measurements. Unlike the triaxial antennas used in wireline tools, systems and methods discussed below are simplified antenna configurations that effectively acquire the necessary components to achieve azimuthal sensitivity and determine a downhole tool's directionality relative to the surrounding formations. Additionally, the proposed designs enable azimuthal measurements without requiring tool rotation. These designs directly capture the minimal set of multi-component signals necessary to replicate azimuthal measurements effectively.

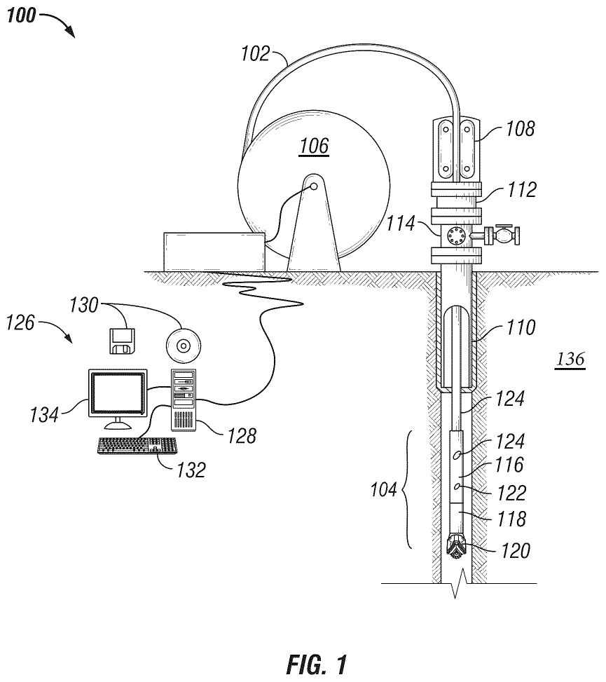

FIG. 1 illustrated coiled tubing system 100, which may include a coiled tubing string 102. It should be noted, that while a coiled tubing string 102 is illustrated, any conveyance that may perform non-rotational operations, such as wireline, may be used. In examples, coiled tubing string 102 may be coupled with a bottom hole assembly (BHA) 104. Coiled tubing string 102 may be disposed around and/or removed from spool 106 by a tubing injector 108 and injected into a wellbore 110 through a packer 112 and a blowout preventer 114. This may allow coiled tubing string 102 to traverse along wellbore 110. As shown, wellbore 110 may be vertically disposed within formation 136. However, wellbore 110 may be of fairly extensive reach eventually turning horizontal within formation 136. Additionally, directional drilling may result in a tortuous wellbore 110 with many bends and turns. Coiled tubing operations may be suited to provide access to such wellbore 110, considering that deploying wireline tools in such wellbore 110 may require a powered tractor tool, adding cost and weight to the instrumentation string and adding time to the operation.

In examples, coiled tubing string 102 may be a continuous length of steel, alloy steel, stainless steel, composite tubing, or other suitable metal or non-metal material that may be flexible enough to be wound on spool 106 for transportation, and spool 106 itself may be located on a coiled tubing truck for mobility (not illustrated). Due to the relative lack of joints, it may be advantageous to use coiled tubing string 102 or performing downhole logging operations in a short amount of time.

In wellbore 110, coiled tubing string 102 may comprise BHA 104 that may comprise a logging sub 116 and a mud motor 118. Mud motor 118 may be utilized to operate drill bit 120. Although not illustrated, BHA 104 may comprise an additional module that may be utilized for telemetry and/or communication. This may allow BHA 104 to communicate between uphole and downhole elements and may also control communication between downhole elements such as the one or more tools/module by providing a common clock, power source, communication bus, and the like. The tools may be subs, or other sections of coiled tubing string 102, that perform functions particular to a coiled tubing operation. For example, in a logging operation, logging sub 116 may comprise multi-physical electromagnetic antennas. As disclosed herein, multi-physical electromagnetic antennas may comprise one or more transmitters 122 and/or one or more receivers 124. Without limitation, coiled tubing applications may be performed offshore as well.

In other examples, BHA 104 may comprise a pulsed-power system for drilling when replaces drill bit 120. Drill bit 120 is mechanical in nature where the pulsed-power system utilizes electricity to form wellbore 110 within formation 136 through arc generation. The pulsed-power system may be referred to as an electrocrushing system or an electrohydraulic system. To generate an arc for removing rock within formation 136, power may be supplied to the pulsed-power system from components downhole, components at the surface and/or a combination of components downhole and at the surface. For example, a generator (not illustrated but may be a part of BHA 104) may generate electrical power and provide that power to a power-conditioning unit. The power-conditioning unit may then transmit electrical energy downhole via surface cable and a sub-surface cable (not expressly shown in FIG. 1) contained within the conveyance or attached to the outer wall of conveyance. As noted above, the conveyance may be coiled tubing string 102, a drill string, or wireline. A pulse-generating (PG) circuit within BHA 104 may receive the electrical energy from the power-conditioning unit and may generate high-energy electrical pulses to drive pulsed-power drill bit. The high-energy electrical pulses may discharge through the rock of formation 136 and/or drilling fluid and may provide information about the properties of the formation and/or drilling fluid.

Tools/modules disposed on coiled tubing string 102 may be controlled by information handling system 126. Additionally, measurements taken and/or performed by the tools may be transmitted to information handling system 126. As illustrated, information handling system 126 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 126 may be a personal computer, a network storage device, or any other suitable device and may vary in size, shape, performance, functionality, and price. Information handling system 126 may comprise a processing unit 128 (e.g., microprocessor, central processing unit, etc.) that may process resistivity logging data by executing software or instructions obtained from a local non-transitory computer readable media 130 (e.g., optical disks, magnetic disks). Non-transitory computer readable media 130 may store software or instructions of the methods described herein. Non-transitory computer readable media 130 may include any instrumentality or aggregation of instrumentalities that may retain data and/or instructions for a period of time. Non-transitory computer readable media 130 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 126 may also include input device(s) 132 (e.g., keyboard, mouse, touchpad, etc.) and output device(s) 134 (e.g., monitor, printer, etc.). The input device(s) 132 and output device(s) 134 provide a user interface that enables an operator to interact with tools coupled to coiled tubing string 102. For example, information handling system 126 may enable an operator to select analysis options, view collected log data, view analysis results, and/or perform other tasks.

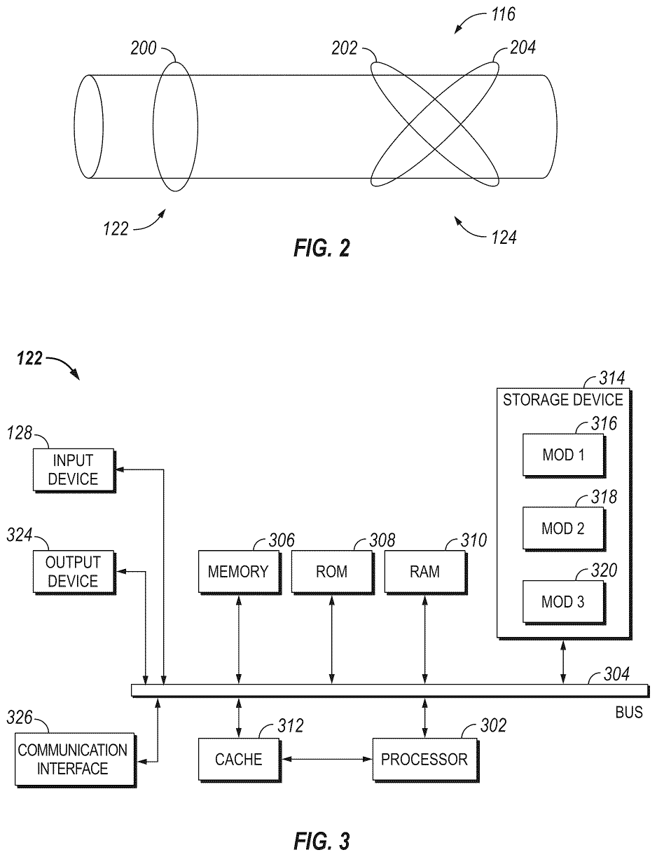

FIG. 2 illustrates an example of logging sub 116 with an antenna structure comprising a transmitter 122, which may be a transmitter coil 200 and a receiver 124 which may be two tilted receiver coils 202 and 204. Transmitter coil 200 in this example may be configured to transmit look-ahead and/or look-around signals that propagate through different areas of a surrounding rock formation. Receiver coils 202 and 204 may be configured to receive the transmitted signal(s). While only transmitter coil 200 and receiver coils 202 and 204 are shown in FIG. 2, it should be noted that additional transmitter and/or receiver coils with different orientation and tilt angles may be used as desired for a particular implementation. In one or more examples, logging sub 116 may be integrated into BHA 104 and disposed within a wellbore 110 being drilled through different layers of formation 136. During operations, logging sub 116 may operate and function to collect measurements of formation properties at different depths as drill bit 120 extends wellbore 110 through formation 136 during the drilling operation. The measurements collected by logging sub 116 may also include, for example, data relating to its own orientation, position, and any other relevant operating conditions.

In one or more examples, the measurements collected by logging sub 116 may be sent to an information handling system 126 located at the surface. The measurements obtained from logging sub 116 may be processed by information handling system 126 may determine formation resistivity and/or other formation properties of interest. It should be noted that measurements obtained from logging sub 116 may also be processed by information handling system 126, which may be disposed on logging sub 116. Further, information handling system 126 that may be disposed on logging sub 116, may perform partial processing and further processing may be performed by information handling system 126 disposed at surface. The measurements may be transferred from logging sub 116 to information handling system 126, for example, a telemetry system, mud pulse communication, wired communication pathway, or wireless connection between logging sub 116 and information handling system 126.

During measurement operations, logging sub 116 may use transmitter coil 200 and receiver coils 202 and 204 to induce an electromagnetic field into the surrounding formation 136 (E.g., referring to FIG. 1) for measuring the formation's resistivity in areas ahead of the tool (look-ahead) and areas above and below the tool (look-around). For example, the look-ahead and/or look-around signals transmitted and received by logging sub 116 may be in the form of an electromagnetic signal including look-ahead and look-around components that propagate through the surrounding formation. Signals may be process utilizing information handling system 126.

FIG. 3 illustrates information handling system 126 which may be employed to perform various blocks, methods, and techniques disclosed herein. As illustrated, information handling system 126 includes a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 126 may include a cache 312 of high-speed memory connected directly with, in close proximity to, or integrated as part of processor 302. Information handling system 126 copies data from system memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. System memory 306 may include multiple different types of memory with different performance characteristics. It may be appreciated that the disclosure may operate on information handling system 126 with more than one processor 302 or on a group or cluster of computing devices networked together to provide greater processing capability. Processor 302 may include any general-purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may include multiple processors, such as a system having multiple, physically separate processors in different sockets, or a system having multiple processor cores on a single physical chip. Similarly, processor 302 may include multiple distributed processors located in multiple separate computing devices but working together such as via a communications network. Multiple processors or processor cores may share resources such as system memory 306 or cache 312 or may operate using independent resources. Processor 302 may include one or more state machines, an application specific integrated circuit (ASIC), or a programmable gate array (PGA) including a field PGA (FPGA).

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 126, such as during start-up. Information handling system 126 further includes storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may include software modules 316, 318, and 320 for controlling processor 302. Information handling system 126 may include other hardware or software modules. Storage device 314 is connected to the system bus 304 by a drive interface. The drives and the associated computer-readable storage devices provide nonvolatile storage of computer-readable instructions, data structures, program modules and other data for information handling system 126. In one aspect, a hardware module that performs a particular function includes the software component stored in a tangible computer-readable storage device in connection with the necessary hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 126 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 126 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, EM waves, and signals per se.

To enable user interaction with information handling system 126, an input device 132 represents any number of input mechanisms, such as a microphone for speech, a touch-sensitive screen for gesture or graphical input, keyboard, mouse, motion input, speech and so forth. Additionally, processing unit 128 may receive one or more EM measurements from logging sub 116 (e.g., referring to FIGS. 1 and 2), discussed above. An output device 324 may also be one or more of a number of output mechanisms known to those of skill in the art. In some instances, multimodal systems enable a user to provide multiple types of input to communicate with information handling system 126. Communications interface 326 generally governs and manages the user input and system output. There is no restriction on operating on any particular hardware arrangement and therefore the basic hardware depicted may easily be substituted for improved hardware or firmware arrangements as they are developed.

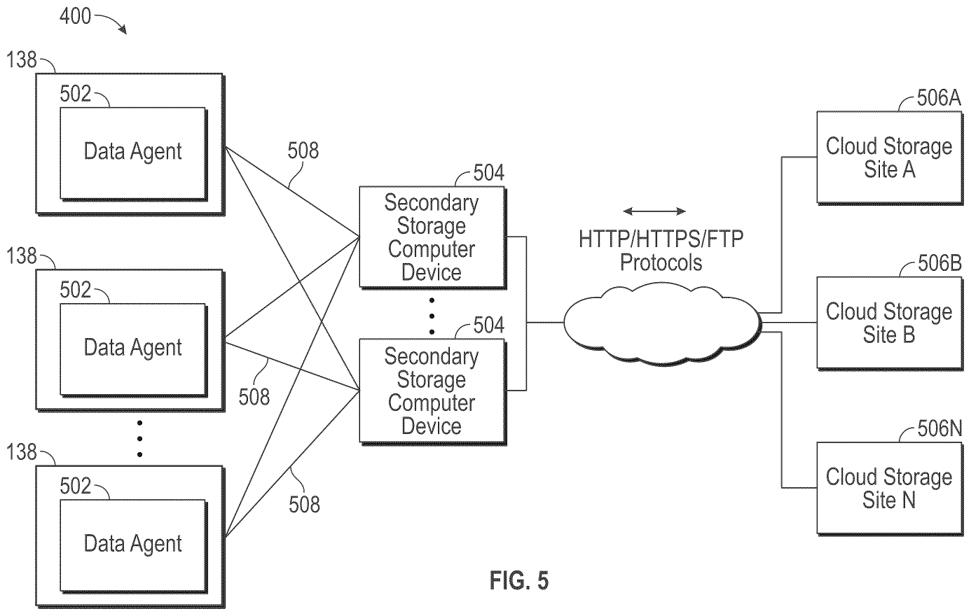

As illustrated, each individual component described above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general-purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

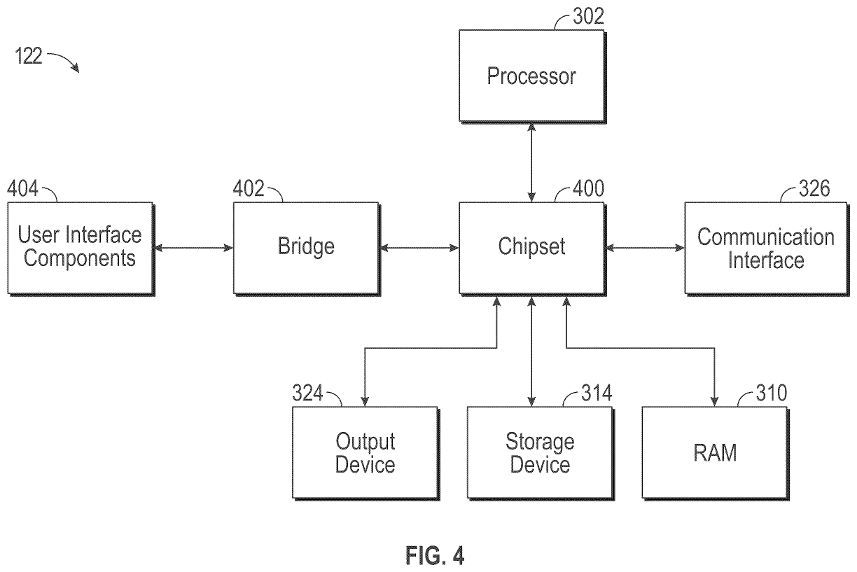

FIG. 4 illustrates an example of information handling system 126 having a chipset architecture for information handling system 126 that may be used in executing the described method and generating and displaying a graphical user interface (GUI). Information handling system 126 is an example of computer hardware, software, and firmware that may be used to implement the disclosed technology. Information handling system 126 may include a processor 302, representative of any number of physically and/or logically distinct resources capable of executing software, firmware, and hardware configured to perform identified computations. Processor 302 may communicate with a chipset 400, discussed below, that may control input to and output from processor 302. In this example, chipset 400 outputs information to output device 324, such as a display, and may read and write information to storage device 314, which may include, for example, magnetic media, and solid-state media. Chipset 400 may also read data from and write data to RAM 310. Bridge 402 for interfacing with a variety of user interface components 404 may be provided for interfacing with chipset 400. Such user interface components 404 may include a keyboard, a microphone, touch detection and processing circuitry, a pointing device, such as a mouse, and so on. In general, inputs to information handling system 126 may come from any of a variety of sources, machine generated and/or human generated.

Chipset 400 may also interface with one or more communication interfaces 326 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 302 analyzing data stored in storage device 314 or RAM 310. Further, information handling system 126 receives inputs from a user via user interface components 404 and executes appropriate functions, such as browsing functions by interpreting these inputs using processor 302.

In examples, information handling system 126 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include programming modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing blocks of the methods disclosed herein. The particular sequence of such executable instructions or associated data structures represents examples of corresponding acts for implementing the functions described in such blocks.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

FIG. 5 illustrates an example of one arrangement of resources on a computing network 500 that may employ the processes and techniques described herein, although many others are of course possible. As noted above, an information handling system 126, as part of their function, may utilize data, which includes files, databases, directories, metadata (e.g., access control list (ACLS) creation/edit dates associated with the data, etc.), and other data objects. The data on the information handling system 126 is typically a primary copy (e.g., a production copy). During a copy, backup, archive or other storage operation, information handling system 126 may send a copy of some data objects (or some components thereof) to a secondary storage computing device 504 by utilizing one or more data agents 502.

A data agent 502 may be a desktop application, website application, or any software-based application that is run on information handling system 126. As illustrated, information handling system 126 may be disposed at any rig site (e.g., referring to FIG. 1), off site location, core laboratory, repair and manufacturing center, and/or the like. In examples, data agent 502 may communicate with a secondary storage computing device 504 using communication protocol 508 in a wired or wireless system. Communication protocol 508 may function and operate as an input to a website application. In the website application, field data related to pre- and post-operations, generated DTCs, notes, and/or the like may be uploaded. Additionally, information handling system 126 may utilize communication protocol 508 to access processed measurements, EM measurement, historical run data, and/or the like. This information is accessed from secondary storage computing device 504 by data agent 502, which is loaded on information handling system 126.

Secondary storage computing device 504 may operate and function to create secondary copies of primary data objects (or some components thereof) in various cloud storage sites 506A-N. Additionally, secondary storage computing device 504 may run determinative algorithms on data uploaded from one or more information handling systems 126, discussed further below. Communications between the secondary storage computing devices 504 and cloud storage sites 506A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 504 may also perform local content indexing and/or local object-level, sub-object-level or block-level deduplication when performing storage operations involving various cloud storage sites 506A-N. Cloud storage sites 506A-N may further record and maintain, EM logs, EM measurements, store operational data, and/or provide outputs from determinative algorithms that are located in cloud storage sites 506A-N. In a non-limiting example, this type of network may be utilized as a platform to store, backup, analyze, import, perform extract, transform and load (“ETL”) processes, mathematically process, apply machine learning models, and augment data sets. Processing of EM measurements from logging sub 116 may differ considerably depending on whether logging sub 116 is rotating or not rotating.

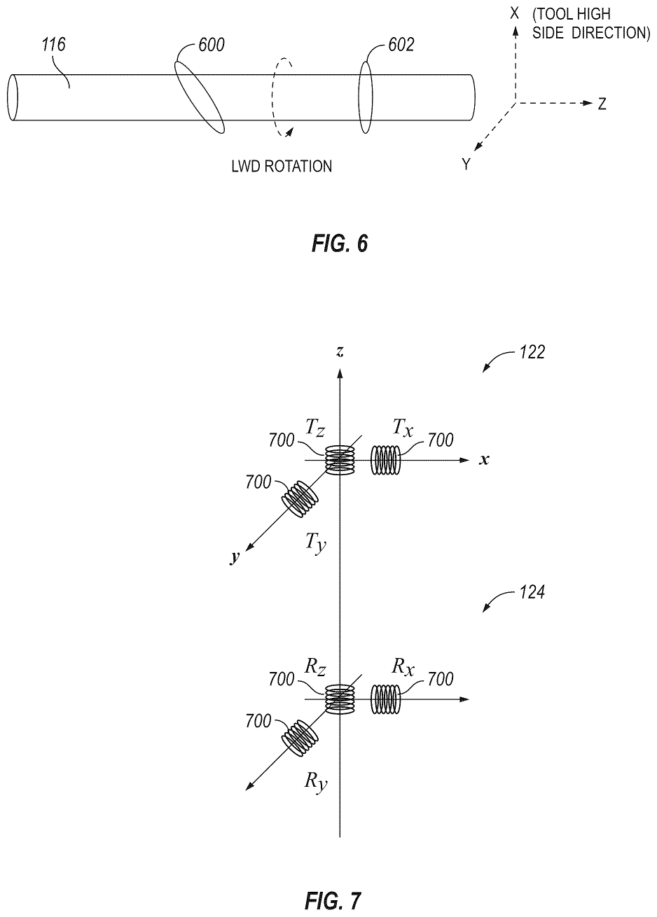

Conventional logging subs that measure EM resistivity may utilize tilted antenna designs to enable azimuthal sensitivity, resulting in directional drilling decisions. As discussed above, conventional logging subs 116 rotate during measurement operations. The rotation comes from the rotation of a drill string during logging while drilling (LWD) operations. For conventional logging where logging sub 116 rotates, as shown in FIG. 6, tilted receiver 600 and transmitter 602 rotate with logging sub 116 during the LWD rotational drilling activities, allowing tilted receiver 600 to measure azimuthal sensitivity to the surrounding formations 136 (e.g., referring to FIG. 1). For the configuration illustrated in FIG. 6, the azimuthal measurement (V) may mathematically be expressed by the equation below:

$$V ( β ) = {V}_{ZZ} + {V}_{ZX} cos ( β + {β}_{bed} ) + {V}_{ZY} sin ( β + {β}_{bed} ) \qquad ( 1 )$$

where the β is the tool azimuth angle relative to logging sub 116 high side direction (normally defined by the magnetic binning system), and the β_{bed} is the relative angle difference between the logging sub 116 normal direction of the surrounding formation boundaries and logging sub 116 high side direction.

However, for operations such as wireline applications, triaxial antennas 700 at both transmitters 122 and receivers 124 may be utilized to achieve the azimuthal sensitivity, as shown in FIG. 7. The three orthogonal transmitters and three orthogonal receivers enable the so-called multi-component magnetic tensor matrix, as described in the equation below:

$$[ \begin{matrix}{H}_{XX} & {H}_{YX} & {H}_{ZX} \\ {H}_{XY} & {H}_{YY} & {H}_{ZY} \\ {H}_{XZ} & {H}_{YZ} & {H}_{ZZ}\end{matrix} ] \qquad ( 2 )$$

where Hᵢⱼ is the magnetic field measurement received at the i-oriented receiver antenna with respect to the j-oriented transmitter antenna firing. It should be noted that i and j may be in x, y or z direction relative to logging sub 116 (e.g., referring to FIG. 6) high side direction.

However, measuring the full magnetic tensor is not necessary to achieve azimuthal sensitivity in LWD non-rotational operations. Non-rotational operations refer to activities such as a slide drilling operation and drilling without rotating logging sub 116, which may be disposed on BHA 104, in relation to formation 136 (e.g., referring to FIG. 1), during which stationary measurements may be taken. Specifically, drilling operations using a pulsed-power system, as described above, to perform drilling operations in which rotation of the pulsed-power system is not performed. Generally, the conveyance does not rotate during drilling operations, however it is noted that over the length of wellbore 110 the conveyance may rotate over an extended length if measuring from the surface. By disposing logging sub 116 within BHA 104, which may be attached to the pulsed-power system, drilling operations utilizing the pulsed-power system may be monitored and controlled at least in part from stationary measurements taken by logging sub 116 even though rotation is not utilized during the drilling process. Additionally, stationary measurements may also be taken during slide drilling operations.

As disclosed herein slide drilling is where the bottom hole assembly (BHA), which may comprise logging sub 116, remains stationary while drilling into the formation, allowing for static measurements to be taken at a specific depth along wellbore 110. During non-rotational operations, the azimuthal of logging sub 116 orientation may vary at any angle relative to a high side of logging sub 116, causing antenna (i.e., transmitter 122 and/or receiver 124) of logging sub 116 to assume a random azimuthal position along wellbore 110. This leads to uncontrolled antenna orientation at adjacent depths and no azimuthal measurements may be acquired. As a result, methods and systems disclosed below disclose various advanced tilted antenna designs that may utilize fewer antennas than the triaxial configuration shown in FIG. 7 while still effectively replicating azimuthal responses without rotation.

As discussed below, there are two different methods for implementing a tilted antenna coil (i.e., transmitter 122 and/or receiver 124), during non-rotational operations. One method adjusts the orientation of tilted antenna coil (i.e., transmitter 122 and/or receiver 124), known as the tilt angle, with respect to the mandrel direction (X-Z plane in FIG. 6) of logging sub 116, while the other, known as the azimuth angle, rotates the tilted antenna coil (i.e., transmitter 122 and/or receiver 124) along the X-Y plane in FIG. 6. These designs achieve azimuthal sensitivity to the surrounding formations 136 (e.g., referring to FIG. 1) by acquiring the minimum number of multi-component measurements.

As discussed below, FIGS. 8-12 disclose a number of embodiments in which a minimum number of components that form multi-component magnetic tensor matrix may be measured with logging subs 116 may be utilized to achieve non-rotation azimuthal measurements. As discussed herein, azimuthal measurements may be measurements of azimuthal geosignals or azimuthal resistivities. Additionally, an inversion may be performed in information handling system 126 using measurements from one or more components of multi-component magnetic tensor matrix to determine one or more formation electrical properties surrounding wellbore 110. One or more formation electrical properties may be a formation resistivity, a formation anisotropy, or one or more formation bed boundaries.

FIG. 8 illustrates logging sub 116 in which a transmitter 122 and plurality of receivers 124 may be utilized. In FIG. 8, transmitter 122 may be coaxial with logging sub 116 (i.e., a coaxial transmitter). Coaxial is defined at a non-tilt transmitter 122 being perpendicular to logging sub 116. In FIG. 8, a receiver 124 may be coaxial to logging sub 116, a 45 degrees tilted receiver 124 with azimuth at 120 degrees, and a 45 degrees tilted receiver 124 with azimuth at 240 degrees. Further all three receivers 124 may be at different tilt angles and different azimuths and none of them may be coaxial. During stationary measurements, a multi-component magnetic tensor matrix may be generated using the configuration of FIG. 8, seen below.

$$[ \begin{matrix}- & - & ZX \\ - & - & ZY \\ - & - & ZZ\end{matrix} ] \qquad ( 3 )$$

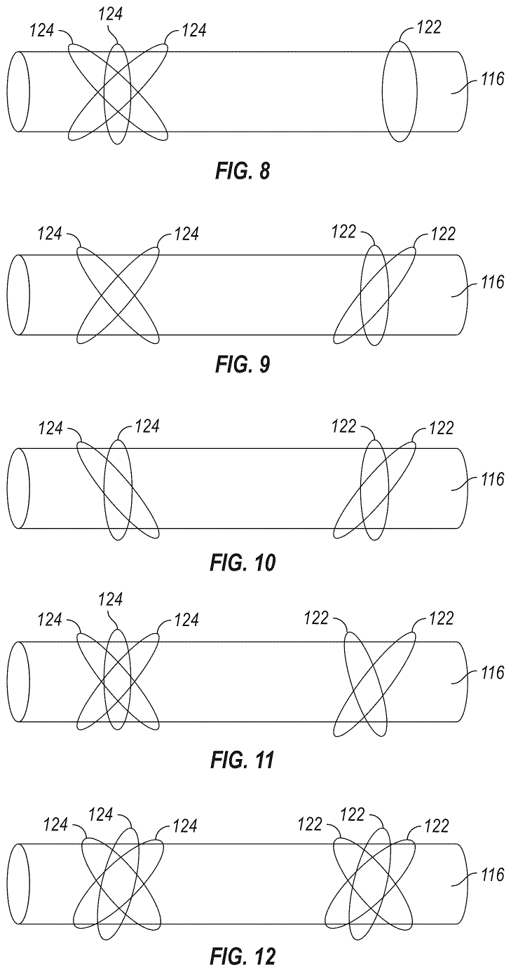

FIG. 9 illustrates logging sub 116 in which a plurality of transmitters 122, which may be tilted and referred herein as tilt transmitters 122, and plurality of receivers 124, which may be tilted and referred herein as tilt receivers 124, may be utilized. In FIG. 9, a tilt transmitter 122 may be oriented at a first azimuth (such as ninety degrees) and second transmitter 122 may be a coaxial antenna. Additionally, both tilt receivers 124 may have a second azimuth (such a zero degrees) and collocated. During stationary measurements, a multi-component magnetic tensor matrix may be generated using the configuration of FIG. 9, seen below.

$$[ \begin{matrix}- & YX & ZX \\ - & - & - \\ - & YZ & ZZ\end{matrix} ] \qquad ( 4 )$$

FIG. 10 illustrates logging sub 116 in which a plurality of transmitters 122 and plurality of receivers 124 may be utilized. In FIG. 10, a non-tilt transmitter 122 may be coaxial to logging sub 116 and tilt transmitter 122 may be oriented at a 0-degree azimuth. Additionally, one tilt receiver 124 may be collocated at 90-degree azimuth whereas another receiver 124 may be coaxial. During stationary measurements, a multi-component magnetic tensor matrix may be generated using the configuration of FIG. 10, seen below.

$$[ \begin{matrix}- & - & - \\ XY & - & ZY \\ XZ & - & ZZ\end{matrix} ] \qquad ( 5 )$$

FIG. 11 illustrates logging sub 116 in which a plurality of transmitters 122 and plurality of receivers 124 may be utilized. In FIG. 11, two different tilt transmitters 122 at the azimuth of 0 degrees may be collocated. Additionally, three receivers 124 may be utilized. As illustrated, two tilt receivers 124 may be collocated at 0- and 90-degrees azimuth angles, respectively, and a third receiver 124 may be coaxial (i.e., a coaxial receiver). During stationary measurements, a multi-component magnetic tensor matrix may be generated using the configuration of FIG. 11, seen below.

$$[ \begin{matrix}XX & - & ZX \\ XY & - & ZY \\ XZ & - & ZZ\end{matrix} ] \qquad ( 6 )$$

FIG. 12 illustrates logging sub 116 in which a plurality of transmitters 122 and plurality of receivers 124 may be utilized. In FIG. 12, three tilt transmitters 122 oriented at three different azimuth angles (For example, 0, 120 and 240 degrees) may be collocated, whereas three tilt receivers 124 oriented at three different azimuth angles (For example, 0, 120 and 240 degrees) may be collocated. During stationary measurements, the full multi-component magnetic tensor matrix may be generated using the configuration of FIG. 12, seen below. Although this configuration utilizes the tilted antenna design, the nth configuration essentially requires the same amount of the antennas as the wireline configuration.

$$[ \begin{matrix}XX & YX & ZX \\ XY & YY & ZY \\ XZ & YZ & ZZ\end{matrix} ] \qquad ( 7 )$$

As shown in the Eq. (1), the azimuthal measurements of the conventional resistivity tool while rotation contains only three multi-component measurements of the multi-component magnetic tensor matrix, which is, the ZZ, ZX and ZY component. This may be achieved by the antenna designs in FIGS. 11 and 12, which may utilize the same number of antennas as the triaxial wireline configuration, referring back to FIG. 7. Consequently, to achieve the minimum multi-components of the multi-component magnetic tensor matrix needed for an azimuthal response, the use of Eq. (8) and Eq. (9) are proposed based on the antenna designs from FIGS. 8-11.

$$V ( {β}_{any} ) = {V}_{ZZ} + {V}_{ZX} cos ( {β}_{any} ) + {V}_{YZ} sin ( {β}_{any} ) \qquad ( 8 )$$

$$V ( {β}_{any} ) = {V}_{ZZ} + {V}_{XZ} cos ( {β}_{any} ) + {V}_{ZY} sin ( {β}_{any} ) \qquad ( 9 )$$

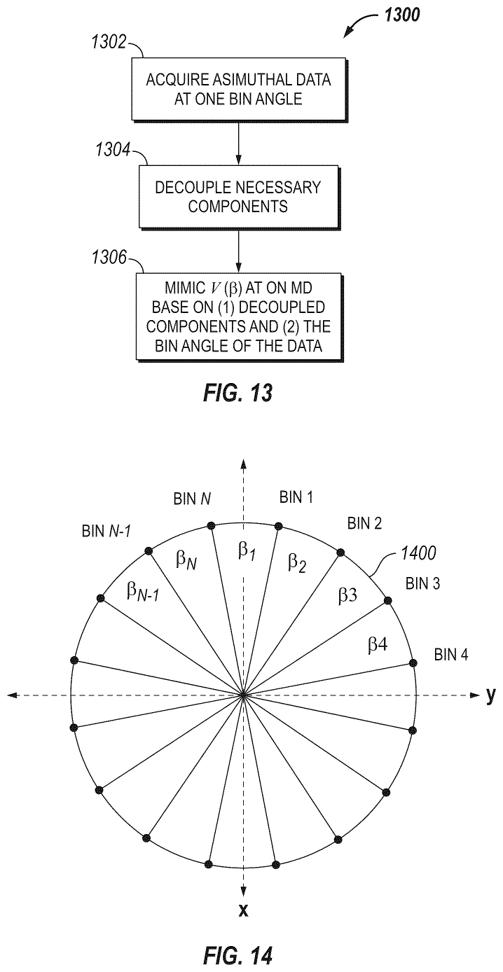

FIG. 13 illustrates the detailed workflow 1300 of logging sub 116 that mimics azimuthal measurements without rotation of logging sub 116. It should be noted that at least a part of workflow 1300 may be performed on information handling system 126 (e.g., referring to FIG. 1). Workflow 1300 may begin with block 1302. In block 1302 an azimuthal data point may be acquired at one bin angle for a bin 1400 during non-rotational operations, referring to FIG. 14. In block 1304, all selected components from multi-component magnetic tensor matrix (Eqs. (2)~(7)) may be decoupled using measurements of specific antenna configurations (FIGS. 8~12). The decoupling involves applying mathematical or signal processing techniques to separate specific response from the original measurements. The decoupled components may be calculated using summation or subtraction among a single bin 1400 of data, referring to FIG. 14, from each receiver measurement corresponding to each transmitter firing, as the antenna configurations described above. These single-bin data points are used to compute the individual components listed each matrix for each design described above. However, as logging sub 116 is not rotated, it is not possible to determine the relative bed azimuth directly, as shown in Equation (1). To address this, in block 1306, V(β), which is a mimic azimuthal measurement based on mathematical calculations of decoupled component and the azimuth angle of logging sub 116 relative to logging sub 116 high side direction, at one measured depth. For example, the cross-component signals between the Z and X axis (V_{zx}), as well as the Z and Y (V_{zy}) axis, are used to mimic the azimuthal response. This is achieved using cosine and sine functions either based on Eq. (8) or (9), both presenting the mimic azimuthal responses without rotational binned data. For example, amplitudes of V_{zx} and V_{zy} may cause a shift in the mimic azimuthal response. For example, when the X-axis is aligned with the normal direction of the surrounding formation boundaries, the amplitude of V_{zy} is zero, causing the azimuthal response to behave as a pure cosine function in Eq. (8) or (9). Conversely, when the X-axis is oriented differently from the normal of the surrounding formation boundaries, neither V_{zx} nor V_{zy} is zero, resulting in an azimuthal response that combines both cosine and sine functions in Eq. (8) and Eq. (9). This, in turn, causes an azimuthal shift in the mimic azimuthal responses. As the single-bin data (β_{any} in Eqs. (8) and (9)) may correspond to any angle relative to logging sub's 116 tool's high side, the X and Y directions of the decoupled components derived from these data may differ from the X and Y directions defined in Equation (1) and FIG. 6. Equations (8) and (9) may enable the projection of these new X and Y directions back to the original X and Y coordinate system, as defined in Equation (1), using cosine and sine transformations.

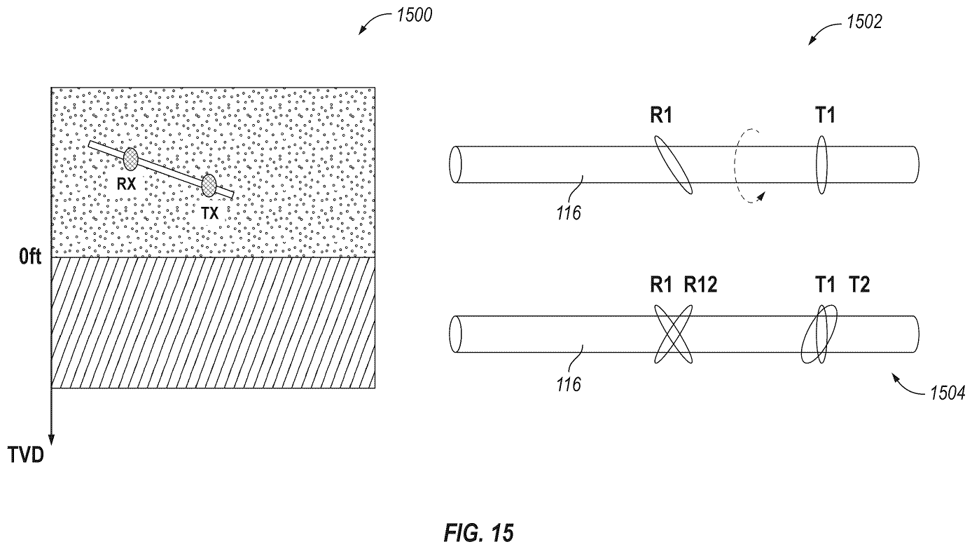

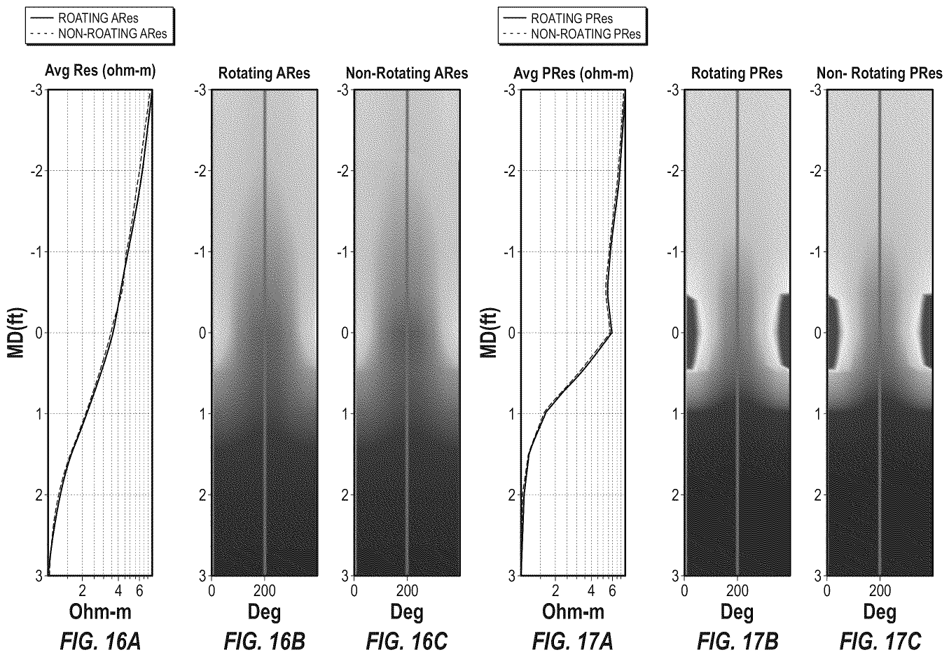

The methods and systems describe above are validated with the computation described below and performed at least in part on information handling system 126. FIG. 15 illustrates a two-layered, one-dimensional (1D) formation model 1500 to evaluate the azimuthal measurements of a conventional LWD logging sub 116 disposed on BHA 1502 that rotates when taking azimuthal measurements and logging sub 116 disposed on BHA 1504 discussed above that is non-rotational when taking azimuthal measurements. FIGS. 16A-16C are graphs that display the synthetic azimuthal measurements obtained from BHA 1502 and BHA 1504 for attenuation resistivity “ARes”. FIGS. 17A-17C are graphs that display the synthetic azimuthal measurements obtained from BHA 1502 and BHA 1504 for phase resistivity “PRes”. As shown in FIGS. 16A-16C and FIGS. 17A-17C, the azimuthal measurements produced by BHA 1502 and BHA 1504 are similar in relation to the geological features of formation 136 (e.g., referring to FIG. 13). Since the boundary of the layered formation model is parallel to wellbore 110 (and aligned with logging sub's 116 high side), the azimuthal responses exhibit sinusoidal behavior, with the peak of the sine wave occurring at 0 degrees.

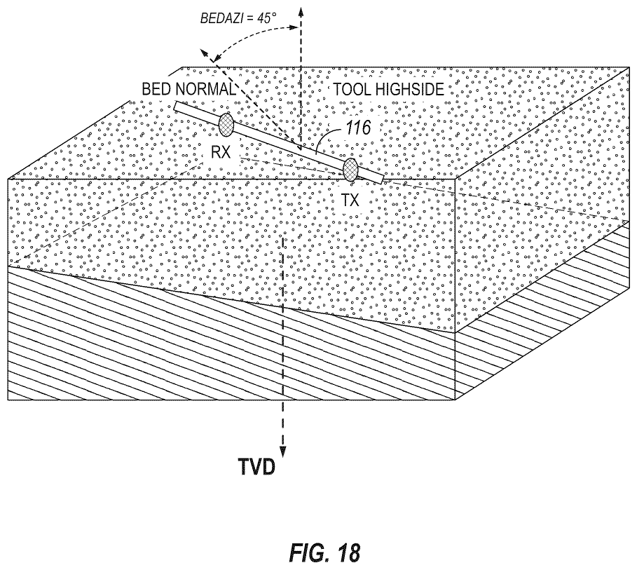

FIG. 18 illustrates logging sub's 116 high side directions at varying angles relative to the normal direction of the formation boundary (relative bed azimuth) may be evaluated. In this scenario, the relative azimuth angle is set to 45 degrees. As previously mentioned, the non-rotational tool does not ensure a fixed tool azimuth angle during measurements, whereas the rotational LWD tool captures comprehensive azimuthal measurements, enabling azimuthal sensitivity relative to the formation.

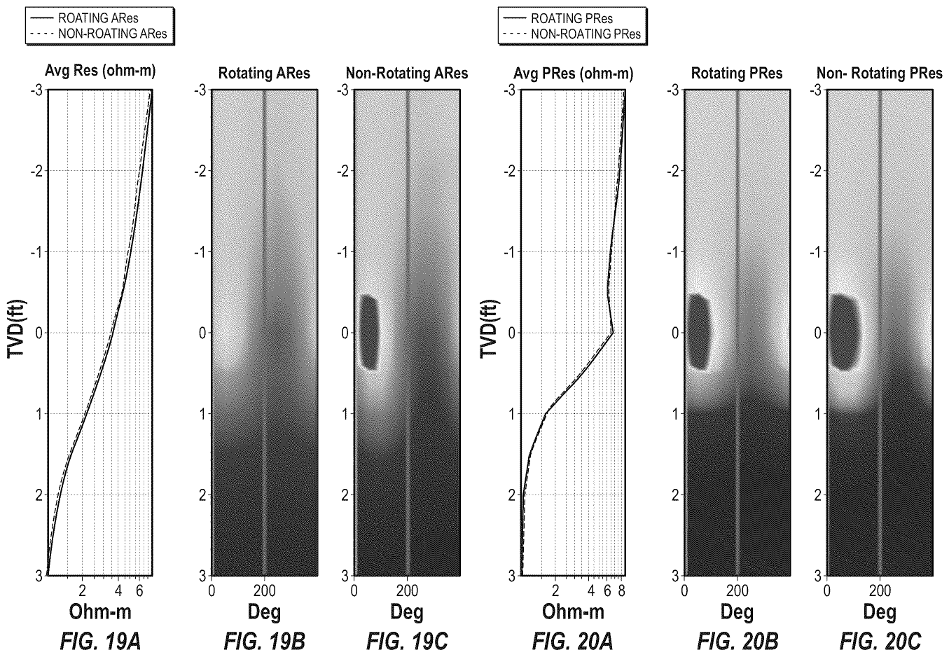

FIGS. 19A-19C are graphs that illustrate the synthetic modeling responses for both tools in the formation model in FIG. 18 for attenuation resistivity “ARes”. FIGS. 20A-20C are graphs that illustrate the synthetic modeling responses for both tools in the formation model in FIG. 18 for phase resistivity “PRes”. For BHA 1502 (e.g., referring to FIG. 15) in which logging sub 116 rotates, the sinusoidal responses exhibit a phase shift of 45 degrees, corresponding to the bed azimuth angle. Similarly, for BHA 1504 (e.g., referring to FIG. 15) in which logging sub 116 does not rotate, generates comparable azimuthal responses to BHA 1502, also showing a phase shift of 45 degrees. This demonstrates that the mimic azimuthal responses from BHA 1504 aligns closely with the actual azimuthal responses obtained from BHA 1502.

While the peak values of the azimuthal responses from BHA 1504 (based on Eq. (8)) may differ slightly from those BHA 1502 (based on Eq. (1)), both designs consistently capture the directional sensitivity of the azimuthal measurements relative to formation 136 (e.g., referring to FIG. 1). This ensures the reliability of geosteering decisions derived from either approach.

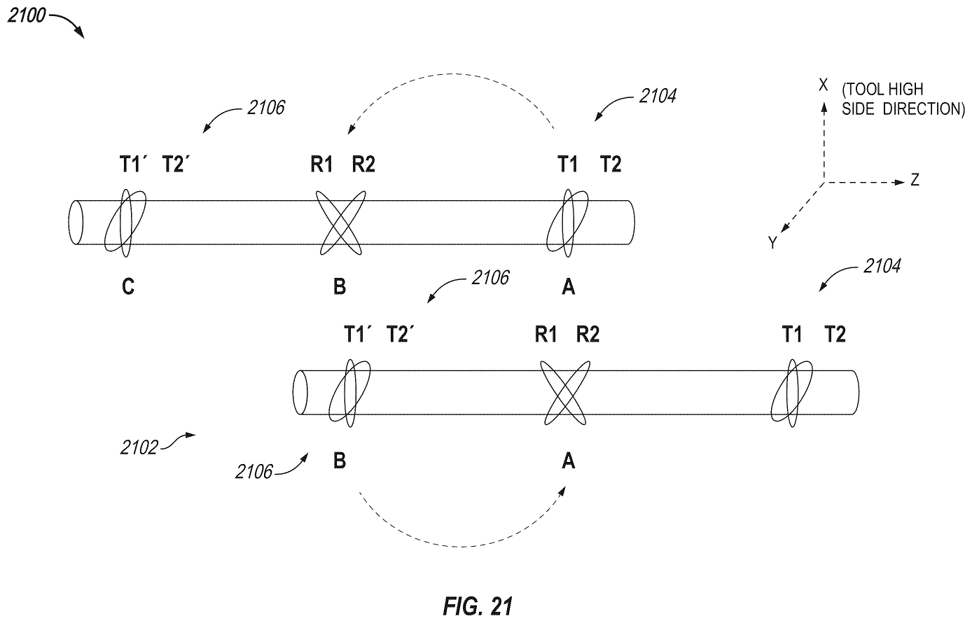

An alternative approach to ensure the azimuthal responses of BHA 1502 closely match those of BHA 1504 may comprise methods and systems using a symmetrical antenna structure, as depicted in FIG. 21. This symmetrical configuration provides additional multi-components of the multi-component magnetic tensor matrix and increased azimuthal response. However, it necessitates the use of a depth shift algorithm, wherein measurements are taken at two different measured depth (MD) locations, MD₁ 2100 and MD₂ 2102, as shown in FIG. 21. This algorithm aligns the upper-side receivers 2104 (R1 and R2) with the lower-side transmitters 2106 (T1′ and T2′) to ensure that the decoupled components capture the same formation properties surrounding the antennas (i.e., transmitter 122 and/or receiver 124).

For example, referring back to FIG. 8, a multi-component magnetic tensor matrix at MD₁ is defined as seen above in Eq (3) and the multi-component magnetic tensor matrix at MD₂ is defined as seen below as:

$$[ \begin{matrix}- & - & - \\ - & - & - \\ XZ & YZ & ZZ\end{matrix} ] \qquad ( 10 )$$

Referring back to FIG. 9, a multi-component magnetic tensor matrix at MD₁ is defined as seen above in Eq (4) and the multi-component magnetic tensor matrix at MD₂ is defined as seen below as:

$$[ \begin{matrix}- & - & - \\ XY & - & ZY \\ XZ & - & ZZ\end{matrix} ] \qquad ( 11 )$$

Referring back to FIG. 10, a multi-component magnetic tensor matrix at MD₁ is defined as seen above in Eq (5) and the multi-component magnetic tensor matrix at MD₂ is defined as seen below as:

$$[ \begin{matrix}- & YX & ZX \\ - & - & - \\ - & YZ & ZZ\end{matrix} ] \qquad ( 12 )$$

Referring back to FIG. 11, a multi-component magnetic tensor matrix at MD₁ is defined as seen above in Eq (6) and the multi-component magnetic tensor matrix at MD₂ is defined as seen below as:

$$[ \begin{matrix}XX & YX & ZX \\ - & - & - \\ XZ & YZ & ZZ\end{matrix} ] \qquad ( 13 )$$

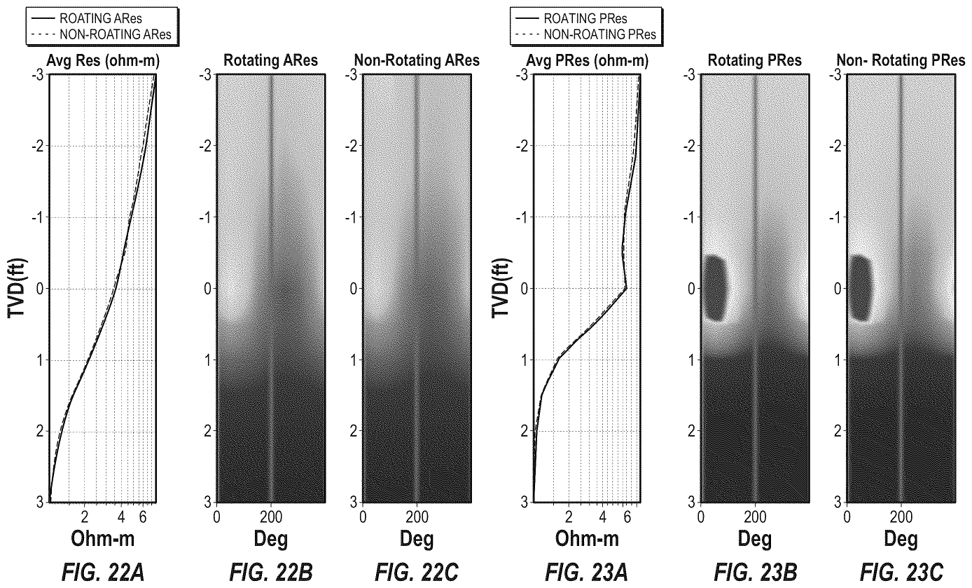

FIGS. 22A-22C compares the azimuthal measurements obtained using BHA 1502 and BHA 1504 featuring the symmetrical antenna structure 2100, as described in FIG. 21, for attenuation resistivity “ARes”. FIGS. 23A-23C compares the azimuthal measurements obtained using BHA 1502 and BHA 1504 featuring the symmetrical antenna structure 2100, as described in FIG. 21, for phase resistivity “PRes”. The results illustrate an excellent match between the two designs, validating the effectiveness of the proposed symmetrical configuration in replicating azimuthal responses.

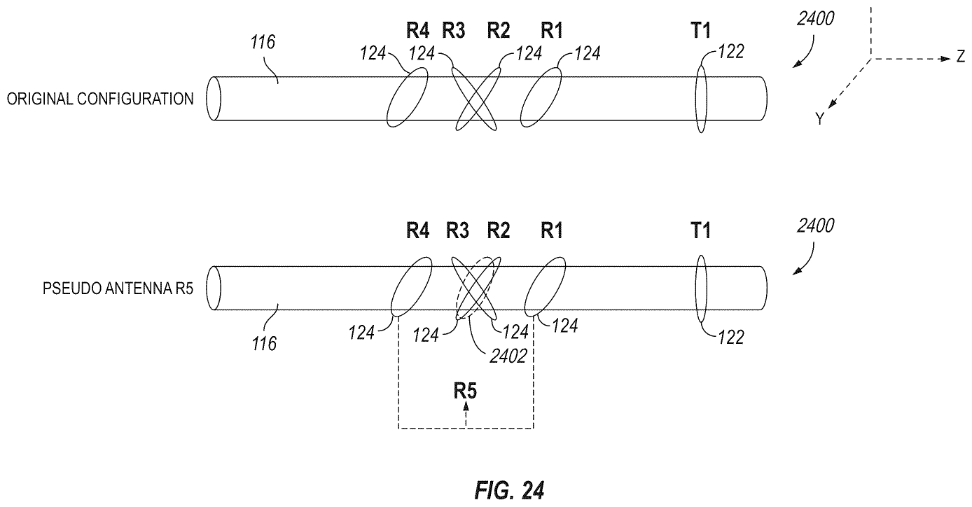

Another alternative embodiment to achieve BHA 1504 tool measurements employs pseudo antenna measurement based on the measurement superposition of the multi-physical-antenna configurations 2400 of logging sub 116, as shown in FIG. 24. FIG. 24 illustrates logging sub 116 which may comprise four physical receivers 124 (R1~R4) for measuring signals from transmitter 122 (T1). Both R1 and R4 receiver antenna have the same antenna orientation relative to transmitter T1 as well as the same distance to the collocated receivers (R2 & R3). Therefore, the measurements of T1R1 and T1R4 may be added to mimic measurement of pseudo antenna 2402 where 2402 would be equivalently located at the location identical to the R2 and R3 locations. With pseudo antenna 2402 along with the physical antenna R2 and R3, a triaxial receiver configuration may be achieved relative to transmitter 122, which is representative of the configuration in FIG. 8 that may utilize Eq (3) and (10). Similarly, any physical antenna configuration for FIGS. 8-12 may be achieved with pseudo antenna measurements on the basis of the superposition of two additional antennas separated within a certain distance, where the pseudo antenna position may be in the middle of the two additional antennas.

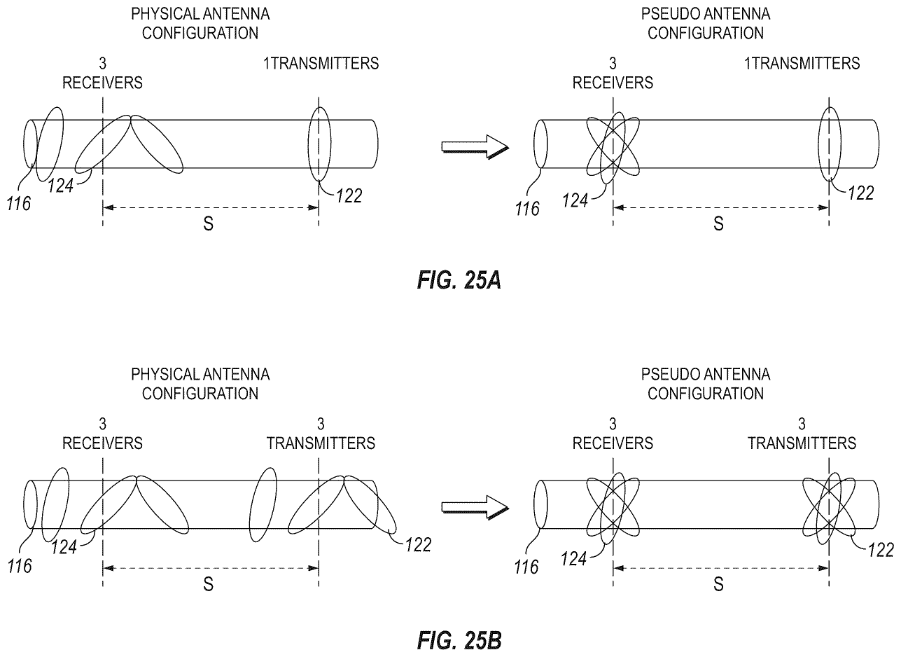

FIGS. 25A and 25B illustrate additional embodiments to achieve pseudo antennas. In FIG. 25A, a physical configuration of tilted receivers 124 and a transmitter 122 that is coaxial with logging tool 116 is illustrated. The variable S is a spacing between tilted receivers 124 and transmitter 122. Using the methods described above, a pseudo antenna is formed from measurements of the three tilted receivers 124. This pseudo antenna configuration mimics the configuration of FIG. 8. FIG. 25B illustrates a physical configuration of tilted receivers 124 and tilted transmitters 122 disposed on logging tool 116. The variable S is a spacing between tilted receivers 124 and tilted transmitters 122. Using the methods described above, a pseudo antenna is formed from measurements of the three tilted receivers 124 and three tilted transmitters 122. This pseudo antenna configuration mimics the configuration of FIG. 12.

As discussed above, the methods and systems are improvements over conventional technology. Specifically, conventional tools acquire azimuthal responses while rotation, while the proposed systems and methods herein are able to mimic azimuthal measurements without rotation. This is achieved by decoupling necessary multi-components of the multi-component magnetic tensor matrix during stationary measurements and mathematically calculating the azimuthal responses based on the decoupled multi-components from the multi-component magnetic tensor matrix and the tool azimuthal angles.

The preceding description provides various examples of the systems and methods of use disclosed herein which may contain different method steps and alternative combinations of components.

Statement 1. A method may comprise disposing a logging sub into a wellbore, wherein the logging sub comprises a plurality of multi-physical electromagnetic antennas. The method may further comprise performing a slide drilling operation to extend the wellbore into a formation, taking one or more measurements with the logging sub, and identifying one or more properties of the formation from the one or more measurements.

Statement 2: The method of statement 1, further comprising using the one or more measurements to decouple one or more multi-components.

Statement 3: The method of statements 1 or 2, further comprising using the one or more measurements to form one or more azimuthal measurements at one or more azimuth angles of the logging sub relative to a logging sub high side direction.

Statement 4: The method of statement 3, wherein the azimuthal measurements are azimuthal geosignals or azimuthal resistivities.

Statement 5: The method of any previous statements 1-3, wherein the one or more measurements are one or more pseudo antenna measurements.

Statement 6: The method of statement 5, wherein the one or more pseudo antenna measurements are formed from superposition of the plurality of multi-physical electromagnetic antennas of the logging sub.

Statement 7: The method of statement 6, wherein the plurality of multi-physical electromagnetic antennas comprises a coaxial transmitter and a plurality of tilted receivers.

Statement 8: The method of statement 7, wherein a pseudo antenna is formed from at least two of the plurality of tilted receivers.

Statement 9: The method of statement 6, wherein the plurality of multi-physical electromagnetic antennas comprises a plurality of tilted transmitters and a plurality of tilted receivers.

Statement 10: The method of statement 9, wherein a pseudo antenna is formed from at least two of the plurality of tilted receivers or from at least two of the plurality of tilted transmitters.

Statement 11: The method of any previous statements 1-3 or 5, further performing an inversion based on one or more multi-components to determine one or more formation electrical properties surrounding the wellbore, wherein the one or more formation electrical properties may be formation resistivity, formation anisotropy, or formation bed boundaries.

Statement 12: The method of any previous statements 1-3, 5, or 11, wherein the logging sub comprises a coaxial transmitter and two or more tilted receivers.

Statement 13: The method of any previous statements 1-3, 5, 11, or 12, wherein the plurality of multi-physical electromagnetic antennas comprises two or more tilted transmitters and two or more tilted receivers.

Statement 14: The method of any previous statements 1-3, 5, or 11-13, wherein plurality of multi-physical electromagnetic antennas comprises two or more tilted transmitters, one or more tilted receivers, and a coaxial receiver.

Statement 15: A system may comprise a conveyance, configurable to perform a slide drilling operation to form a wellbore in a formation, a logging sub mechanically fixed to the conveyance, wherein the logging sub is configured to take one or more measurements, and an information handling system communicatively connected to the logging sub and configured to identifying one or more properties of the formation from the one or more measurements.

Statement 16: The system of statement 15, wherein the information handling system is further configured to use the one or more measurements to decouple one or more multi-components.

Statement 17: The system of any previous statements 15 or 16, wherein the information handling system is further configured to use the one or more measurements to form one or more azimuthal measurements at one or more azimuth angles of the logging sub relative to a logging sub high side direction.

Statement 18: The system of statement 17, wherein the azimuthal measurements are azimuthal geosignals or azimuthal resistivities.

Statement 19: The system of any previous statements 15-17, wherein the one or more measurements are one or more pseudo antenna measurements.

Statement 20: The system of statement 19, wherein the one or more pseudo antenna measurements are formed from superposition of a plurality of multi-physical electromagnetic antennas disposed on the logging sub.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a logging sub into a wellbore, wherein the logging sub comprises a plurality of multi-physical electromagnetic antennas;
performing a slide drilling operation to extend the wellbore into a formation;
taking one or more measurements with the logging sub; and
identifying one or more properties of the formation from the one or more measurements.

2. The method of claim 1, further comprising using the one or more measurements to decouple one or more multi-components.

3. The method of claim 1, further comprising using the one or more measurements to form one or more azimuthal measurements at one or more azimuth angles of the logging sub relative to a logging sub high side direction.

4. The method of claim 3, wherein the azimuthal measurements are azimuthal geosignals or azimuthal resistivities.

5. The method of claim 1, wherein the one or more measurements are one or more pseudo antenna measurements.

6. The method of claim 5, wherein the one or more pseudo antenna measurements are formed from superposition of the plurality of multi-physical electromagnetic antennas of the logging sub.

7. The method of claim 6, wherein the plurality of multi-physical electromagnetic antennas comprises a coaxial transmitter and a plurality of tilted receivers.

8. The method of claim 7, wherein a pseudo antenna is formed from at least two of the plurality of tilted receivers.

9. The method of claim 6, wherein the plurality of multi-physical electromagnetic antennas comprises a plurality of tilted transmitters and a plurality of tilted receivers.

10. The method of claim 9, wherein a pseudo antenna is formed from at least two of the plurality of tilted receivers or from at least two of the plurality of tilted transmitters.

11. The method of claim 1, further performing an inversion based on one or more multi-components to determine one or more formation electrical properties surrounding the wellbore, wherein the one or more formation electrical properties may be formation resistivity, formation anisotropy, or formation bed boundaries.

12. The method of claim 1, wherein the logging sub comprises a coaxial transmitter and two or more tilted receivers.

13. The method of claim 1, wherein the plurality of multi-physical electromagnetic antennas comprises two or more tilted transmitters and two or more tilted receivers.

14. The method of claim 1, wherein plurality of multi-physical electromagnetic antennas comprises two or more tilted transmitters, one or more tilted receivers, and a coaxial receiver.

15. A system comprising:
a conveyance, configurable to perform a slide drilling operation to form a wellbore in a formation;
a logging sub mechanically fixed to the conveyance, wherein the logging sub is configured to take one or more measurements; and
an information handling system communicatively connected to the logging sub and configured to identifying one or more properties of the formation from the one or more measurements.

16. The system of claim 15, wherein the information handling system is further configured to use the one or more measurements to decouple one or more multi-components.

17. The system of claim 15, wherein the information handling system is further configured to use the one or more measurements to form one or more azimuthal measurements at one or more azimuth angles of the logging sub relative to a logging sub high side direction.

18. The system of claim 17, wherein the azimuthal measurements are azimuthal geosignals or azimuthal resistivities.

19. The system of claim 15, wherein the one or more measurements are one or more pseudo antenna measurements.

20. The system of claim 19, wherein the one or more pseudo antenna measurements are formed from superposition of a plurality of multi-physical electromagnetic antennas disposed on the logging sub.
